(19) United States
(12) Patent Application Publication
(10) Pub. No.: US 2006/0131792 A1
(43) Pub. Date: Jun. 22, 2006

(54) Method of producing a resin bonded moulded part

(76) Inventors: Wolfgang Hogenkamp, Remscheid (DE); Ulrich Reineke, Overath (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/512,302

(22) PCT Filed: Apr. 17, 2003
(86) PCT No.: PCT/EP03/04053

§ 371 Date: Dec. 27, 2005

(30) Foreign Application Priority Data
Apr. 25, 2002 (DE) 102 18 560.3

(51) Int. Cl. B29C 43/00

(52) U.S. Cl. 264/463

(57) ABSTRACT

A moulded part which is pressed, thermally cured and whose surface is thermally treated in a single processing step, whereby the pressure and the temperature are controlled. As a result, shorter processing times are obtained and the process can be carried out in an energy saving manner, said process being able to be controlled extremely precisely. The moulded part can also be degassed.

The invention relates to a method of producing a resin-bonded moulding, in particular a friction lining for a brake lining or clutch lining, wherein a resin-containing pressing material is pressed and thermally cured.

The invention is applicable to the production of any resin-bonded mouldings, which can be produced not only as an individual part but can also simultaneously be connected to functional parts. The main field of application of the invention is the production of friction linings for brake linings or clutch linings, optionally with simultaneous attachment to appertaining support plates with or without the interposition of an underlayer. Another field of application is for example the production of carbon brushes for electric motors.

The resin-bonded pressing materials are powdered mixtures which are pressed under high pressure and often with simultaneous heating. The simultaneous heating serves to melt the resins and, depending upon how high the temperature is, to initiate the cross-linking of the resins. The pressing operation is also called moulding. A product which has almost its ultimate shape is produced from the amorphous pressing material by pressing.

However, it lacks the necessary strength. This is produced by the curing, that is to say by the supply of heat at high temperature, whereby the cross-linking of the phenolic resins used as binder takes place.

It has been usual hitherto for a plurality of individually produced mouldings to be subjected simultaneously to the thermal curing. After the moulding operation the mouldings have then been stored temporarily, during which they cool to ambient temperature. The heat loss is particularly great when the pressing has already taken place with heat supplied. Then heating takes place again in the hardening furnace.

The repeated heating operations are energy-consuming and time-consuming. Therefore the object of the invention is to accelerate the production of the moulded part and to improve this in energy terms.

In order to achieve this object the method according to the invention which is referred to in the introduction is characterised in that the pressing and the thermal curing are carried out in one single processing step, the pressure and the temperature being controlled.

Thus no further cooling takes place between the two processing steps. Therefore no additional heating step is necessary. The savings of energy and time are correspondingly high. Additional savings of energy and time are produced by the two processing steps overlapping, that is to say the curing already sets in during the moulding.

Since there is no interim storage, the space required and also the handling costs are reduced. Also the material stocks in circulation are reduced.

During the moulding the system can be operated with substantially lower pressing forces. This has a beneficial effect on the service life of the tools, even when lower standards are set for the tool steel.

Finally, a reduction in the operating equipment is also produced. All that is required is a heatable moulding press in which the workpieces remain until they are completed. Hardening furnaces can be omitted.

It is also possible to omit gripping frames to receive the mouldings after moulding and before use in the hardening furnace. The handling costs are also reduced in this respect. In the past gripping frames were necessary in order to fix the mouldings before and during the curing process, because the mouldings had not yet reached sufficient inherent stability. Also gases which are produced and escape can otherwise lead to destruction of the products. Since in the method according to the invention no handling of the mouldings is necessary after moulding, corresponding measures are unnecessary.

In the case of products which have a specific porosity, the final compressibility is often of crucial importance. This product characteristic is set by the pressing process and by the curing process. The invention offers the possibility of controlling the pressing forces, the pressing times and the pressing temperatures very exactly and in this way achieving very narrow compressibility limits. The invention facilitates in situ control in order to maintain close product tolerances. The pressing operations can be controlled as a function of the force and/or of the path. This facilitates adaptation to the most varied requirements and operating conditions.

In particular in the case of the production of brake linings a surface treatment is necessary, namely strong heating of the friction surface in order to carbonise it. It is only in the carbonised state that the friction lining develops its full frictional effect. By means of so-called scorching it is ensured that the friction lining already exhibits its full effect from the start.

Also the cured friction linings are usually stored temporarily until the surface heating for carrying out the scorching takes place.

In a further development of the invention, on the other hand, the possibility exists of integrating the thermal surface treatment into the single processing step. Thus in this respect additional handling steps and also further heating are omitted. It is also important that the scorching can take place simultaneously with the thermal curing. Thus the duration of the treatment from the start of pressing to the end of the surface treatment is extremely short.

Electric current is preferably passed through the pressing material for thermal curing and for thermal surface treatment. Thus the heat is not supplied externally but is generated within the pressing material. Use is made of the fact that the pressing material is electrically conductive and therefore heats up when current flows through it.

Furthermore it is proposed that electric current flows are generated simultaneously or successively which on the one hand pass through the pressing material and on the other hand run approximately parallel to and close to the surface to be treated. The current flow passing through the pressing material serves for curing, whilst the other current flow effects the scorching. In the case of a friction lining with support plate the scorching is confined to the friction surface. If no support plate is provided, both surfaces of the lining can be scorched.

As already mentioned, simultaneous scorching and curing is particularly advantageous. However, the two operations can also overlap more or less in time.

The current flows are of different intensity depending upon the requirements.

On the side of the friction lining which is to be scorched it is preferable to operate with a matrix of electrodes which have alternately opposing polarities. In this case some of the electrodes operate not only with the opposing support of the press but also with the other electrodes.

During the pressing operation and during the curing reaction gases are produced in the pressing material. Therefore in a further development of the invention it is proposed to degas the pressing material continuously or intermittently during the processing step. In this case the air enclosed during pressing also escapes.

The degassing of the pressing material can be carried out in the pressing direction and/or transversely with respect thereto. Therefore radial degassing is quite particularly advantageous because the lateral surfaces of the moulding are less smooth and solid than the surfaces abutting the ram and the stopper ram retaining plate. The moulding is preferably kept gripped between the ram and the stopper ram retaining plate while the profile insert of the mould, which forms the gripping frame during pressing and initially during curing, is removed upwards or downwards from the moulding and thereby exposes the radial surfaces of the moulding. This operation is also particularly suitable for curing with current supplied, since the ram and the stopper ram retaining plate are electrically isolated from one another with the profile insert removed and are only electrically connected via the moulding.

For further energy saving it is proposed to carry out the processing step with heat insulation provided.

It is particularly important that integrated heat treatment in one single processing step is made possible by the adapted and optimised control of pressure and temperature.

### EXAMPLE

A pressing tool is filled in the usual manner with pressing material. Then the stopper ram retaining plate is lowered onto the profile insert of the tool. Between the profile insert and the stopper ram retaining plate a closing force is generated and then the shaping force is generated between the ram and the assembly comprising the stopper ram retaining plate and the profile insert. The shaping operation is concluded in a period of seconds. Then the closing force can be discontinued. Simultaneously the shaping force is minimised to the amount necessary in order to avoid unacceptable deformation of the moulding under the internal gas pressure and in order to set the compressibility characteristics of the moulding. This force is designated as the clamping force.

Synchronously with the reduction in the forces the profile insert is lowered. The moulding can then emit gas via its radial areas.

Since the resin-bonded pressing materials can be irreversibly compressed under the effect of the clamping force in specific temperature ranges, the clamping force is maintained only over a path which is to be specified. It must be reduced to an amount which only produces a pre-set permissible compression. If the path travelled in the clamping operation is limited and if an accepted amount of shrinkage is achieved, any further change of path is prevented by a stop.

As soon as the profile insert has been lowered, an electric voltage can be applied between the friction side of the gripped moulding and the stopper ram retaining plate. For this purpose the stopper ram retaining plate is electrically isolated from the machine body. The current flowing through the moulding heats up the pressing material homogeneously from the interior outwards.

For simultaneous curing and scorching by electric current a matrix of electrodes with alternating polarities are used on the side of the moulding which is to be surface-treated. Part of the current flows to the other side of the tool and effects the curing. Part of the current flows between adjacent electrodes and ensures the scorching of the appertaining surface.

The system is provided with means which detect the thickness of the moulding, register the changes in path during the process and serve for in situ control of the process.

Temperature sensors with product contact are located in the ram and in the stopper ram retaining plate. The product temperature during the gripping is measured by contact of a sensor on the forming-out slope of the moulding. The temperature sensing also serves for in situ control of the process.

The relatively high shaping force can be sensed from the pressure of a hydraulic system or via the ram. The lower clamping force must be measured and maintained precisely. Therefore the stopper ram retaining plate is equipped with corresponding force sensors. The information from the force measurements also serves for in situ control of the process.

Gases which are produced during the process are led off through an extraction arrangement enclosing the moulding in such a way that as little extraneous air as possible is included. The moulding should not cool due the effect of extraneous air. Conditioned air may optionally be supplied.

The shaping time can be below a second. The shaping temperature is 20° C. to 230° C. The clamping temperature during curing can be up to 800° C.

The shaping force is 5 kN to 250 kN or more, whilst the clamping force is 0.5 kN to 7 kN or more. Both forces are variable during processing. The duration of the clamping may be below five seconds.

The method can be carried out with apparatus of small overall size, for example with apparatus which has a mobile and modular construction. In this case there is no difference between cold and hot presses. Since gas-induced defects (bubbles, cracks, possible loosening of the edges) are avoided, this results in a very low scrap rate.

1-8. (canceled)

9. A method of producing a resin-bonded moulding, wherein a resin-containing pressing material is pressed and thermally cured in one single processing step in which the pressure and the temperature are controlled, and wherein a separately controlled thermal surface treatment is integrated into the single processing step.

10. The method of claim 9, wherein an electric current is passed through the pressing material for thermal curing and for thermal surface treatment.

11. The method of claim 10, wherein electric current flows are generated simultaneously or successively which on the one hand pass through the pressing material and on the other hand run approximately parallel to and close to the surface to be treated.

12. The method of claim 11, wherein the current flows are generated with different intensity.

13. The method of claim 9, wherein the pressing material is degassed continuously or intermittently during the processing step.

14. The method of claim 13, wherein the degassing of the pressing material is carried out in the pressing direction and/or transversely with respect thereto.

15. The method of claim 13, wherein the processing step is carried out with heat insulation provided.

16. The method of claim 9, wherein the resin-bonded moulding is for a friction lining for a brake lining or a clutch lining.
